(19) United States
(12) Patent Application Publication
(10) Pub. No.: US 2019/0110399 A1
(43) Pub. Date: Apr. 18, 2019

(54) Materials Spraying Lawn Maintenance Vehicle

(71) Applicant: Joseph St. Andre, Lafayette, LA (US)

(72) Inventor: Joseph St. Andre, Lafayette, LA (US)

(21) Appl. No.: 15/782,709

(22) Filed: Oct. 12, 2017

(51) Int. Cl. A01D 43/14; A01D 67/00; A01D 75/18

(52) U.S. Cl. CPC A01D 43/14; A01D 2101/00; A01D 75/18; A01D 67/00

(57) ABSTRACT

A lawnmower vehicle with a permanently incorporated materials spraying device for distribution of liquid and solid fertilizers and pest remediating compounds comprised of a sprayer mechanism incorporated into the lawnmower wherein the weight distribution of the lawnmower remains balanced. The sprayer mechanism comprises a materials container in communication with a feeding system for distribution of materials through a nozzle end. The sprayer mechanism may be variously arranged and oriented upon the lawnmower frame as to not offset proper weight distribution for the mower in association with the weight of the engine, mower deck, and fuel container of the lawnmower.

### FIELD OF INVENTION

The subject invention relates generally to vehicle incorporated spraying devices and volume containers. More particularly it relates to an apparatus for use in spraying liquid weed killer, insecticide, fertilizer or other lawn management products in a lawn or garden area which is incorporated within a lawnmower or other user operated gardening vehicle in a balanced manner as to provide precision spraying of contained lawn management products while preventing offset driving of the vehicle, rut formation in a lawn or garden area.

### BACKGROUND OF INVENTION

It is well known in the art that riding lawn mowers and other lawn and garden management vehicles (hereafter, “lawnmower”, “mower”, and “vehicle”) generally have centers of gravity that are relatively high and towards the back of the mower. Such mowers typically incorporate components to adjust the weight distribution of the mower where the grass and lawn trimming blades and motors are housed offset from the relatively empty opposing side. These mowers have proven to be adequate for their intended purpose. However, when the center of gravity is positioned like this, it may create some problems, especially when an attachment is added to spray liquid herbicides, fertilizers, pesticides, fungicides, insecticides and/or repellants and/or any fully dissolvable solid herbicides, fertilizers, pesticides, fungicides, insecticides, repellants, or other lawn management products in a lawn or garden area.

One problem is that the overall length of the mower is relatively long and the overall weight of the commonly known mower is relatively high. This is necessary because extra weight must be added to the front of the mower to help in counter balancing the weight positioned near the back of the mower. Attaching a spraying device to a mower, either behind or beside a driver, can offset the mower's weight distribution, causing the vehicle to sink lower in grass or turf on one side. Improper weight distribution of a mower damages lawns by sinking the tires of one side into the grass or turf and causing ruts during the lawn grooming process. Not to mention that where one side of the mower is lower than the other, the blades of the mower can strike the ground causing gouges in the lawn and encourage damage to the mower blades and motor.

Another problem with attachment of a sprayer device to these riding mowers is that the portion of the mower extending behind the rear wheels can easily scrape the ground whenever the mower is being driven over uneven terrain. Again causing ruts and gouges to a lawn.

Still another problem with some known mowers with blades which are offset from one side is that their manufacture is more complicated due to the complexity of the frame to allow for the cutting unit of mower blades, also known as a “mower deck”, and motors to be housed. Such frames typically include various components that must be bolted together and also typically include various frame members that are bent at various angles to make room for the cutting unit. This leaves a vast amount of wasted space on the other side of the mower. In some conventional mowers such an offset problem has been attempted to be rectified by installing two fuel tanks on either side of the framework's centerline. Yet, this creates its own problems in requiring fuel to be pumped into each tank separately, requiring additional work on the part of a user, and creating the issue that an offset level of fuel in one tank may still throw off the weight balance of the mower.

Another problem is that, due to the portability of attachable sprayer devices, the nozzle section of a sprayer device may be improperly positioned and aimed when attaching a sprayer device to a mower. Improperly positioning a sprayer nozzle can lead to inadequate distribution of sprayer contents, thus ineffectively treatment of a lawn or garden.

Furthermore, temporary attachment of a sprayer device to a mower is disadvantageous as it raises the likelihood of accident. Pesticides used in controlling weeds, insects, etc., are toxic. These chemicals have been created to kill pests and most are broad-spectrum biocides. This means they are poisonous to a wide variety of living organisms, including garden plants, wildlife, pets, your neighbors, your family and you. Inert ingredients, which may comprise 50-99% of a pesticide formula may actually be more toxic than the active ingredients. Many commonly used lawn pesticides are linked with cancer or carcinogenicity, birth defects, reproductive effects, liver or kidney damage, neurotoxicity, and disruption of the endocrine (hormonal) system. Of those same pesticides, many can leach into drinking water sources. Sprayer devices carry large volumes of these chemicals, which in moderation can suit the needs sought. Yet, improper attachment of a portable sprayer device to a mower can result in inadvertent spilling of these chemicals, which in high quantities in one area will kill the grass of a lawn. Even more troubling is the possibly of a spill upon the driver of the mower or someone nearby. Such spills can quickly cause serious chemical burns and even poison an individual if left untreated.

As should be readily apparent, there is a strong need for improvements in mower attached lawn and garden spray devices to reduce these problems. The difficulties inherent in the art are therefore overcome in a way that is simple and efficient, while providing better and more advantageous results.

### SUMMARY OF INVENTION

The present invention is directed to a lawnmower having a permanently incorporated materials spraying mechanism for distributing liquid and/or solid fertilizers, pesticides, fungicides, insecticides and repellants. The spraying mechanism may be configured in a pump to nozzle configuration for distribution of liquid materials and/or fully dissolvable solid fertilizers from a materials tank or as a gravity fed chute to feed solid materials from a materials hopper upon a lawn or garden as desired. The discharge end of the spraying mechanism may be arranged in a handheld wand configuration for directed use by a user, as a permanent attachment to the lawnmower to distribute materials as the mower is driven, or a combination of both.

Organized as such the operator of the lawnmower is allowed to distribute said materials during the operation of mowing a lawn or garden area in a safe and efficient manner without having to physically walk the entire perimeter of the area, thus cutting time and eliminating physical labor. Furthermore, incorporating the spraying mechanism into the operation of the mower is advantageous as it allows for the required energy input to pump or feed materials from a materials container upon a desired area, which would otherwise be required to be physically pumped by the operator, may be carried out during the normal engine and battery operation of the mower.

Permanent incorporation of the spraying mechanism into the framework of the mower is advantageous as it allows the balanced weight distribution of the mower to be maintained. The spraying mechanism may be positioned as desired upon the framework of any variation of lawnmower model to adequately offset any off-center weight of the mower decks, fuel containers, batteries, engine, or other equipment incorporated into the lawnmower. Proper weight distribution is critical to ensuring that lawnmower does not cause ruts or gouges into a lawn or garden area. Another advantage to permanent incorporation is that in lawnmowers with a mower deck offset from the centerline of the lawnmower, the spraying mechanism may be permanently positioned upon the opposite side of the lawnmower centerline to ensure proper weight distribution without the need of complicated framework adjustment or leaving an empty space on one side of the mower framework.

Providing a lawnmower with a permanently incorporated materials spraying mechanism will serve to streamline the time required for lawn maintenance, enhance the user's control of the lawnmower while allowing fertilizers and pesticides to be distributed quickly and easily, as well as serve to maintain the balanced weight distribution of the lawnmower.

### BRIEF DESCRIPTION OF THE DRAWINGS

FIG. 1 is a top down view of the materials spraying lawn maintenance vehicle of the present invention.

FIG. 2 is a side view of the materials spraying lawn maintenance vehicle shown in FIG. 1.

FIG. 3 is a top down view of a zero turn embodiment of the materials spraying lawn maintenance vehicle.

FIG. 4 is a top down view of the materials spraying lawn maintenance vehicle shown in FIG. 1 incorporating a boom spraying device.

FIG. 5 is a side view of an alternate embodiment solid materials spraying lawn maintenance vehicle.

### DESCRIPTION OF EMBODIMENT

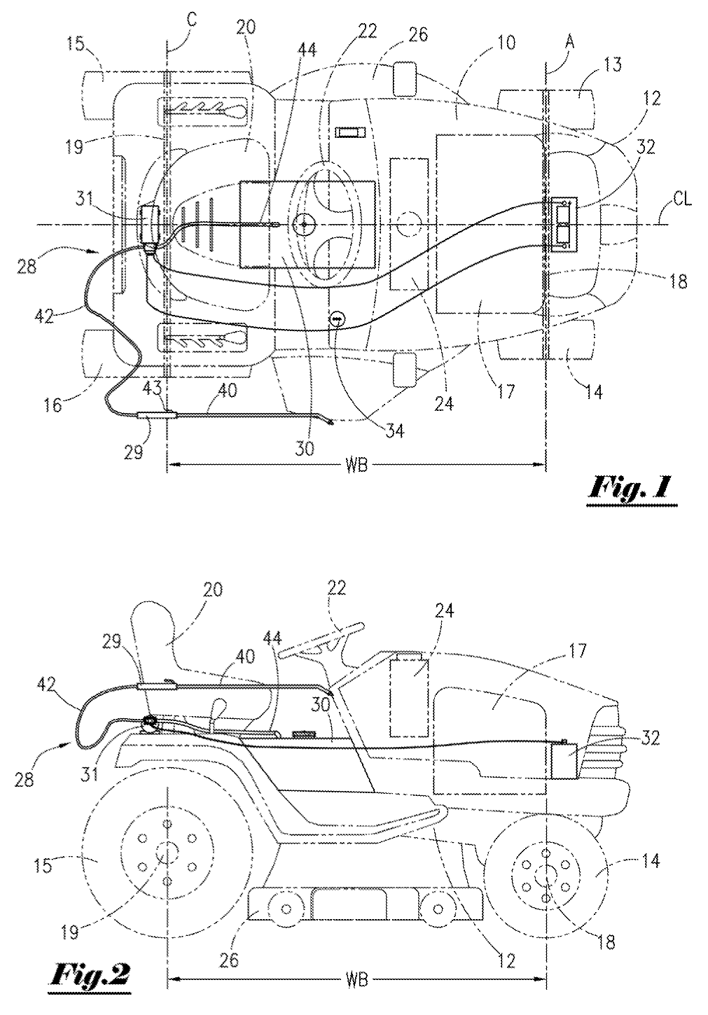

FIGS. 1 & 2 show the riding lawn mower (10) of applicant's invention. The lawn mower (10) is comprised of a frame or chassis (12) having a longitudinal centerline (CL) upon which is mounted first and second front wheels (13, 14) and first and second rear wheels (15, 16) and an operatively attached engine (17). First and second front wheels (13, 14) are attached to frame (12) by front axle (18) and form a front wheel axis (A) that is longitudinally spaced by a wheel base distance (WB) between first and second rear wheels (15, 16). The lawn mower (10) also has a back axle (19) that forms a back axle axis (C).

Mower (10) may also be further arranged with a seat (20) upon the upper surface of frame (12) wherein a steering mechanism (22), pictured as a steering wheel but which may be any conventional steering means, may be positioned to allow for articulation of either front axle (18) in a forward driven embodiment of mower (10), back axle (19) in a rear driven or zero turn embodiment of mower (10), or both front axle (18) and back axle (19). Engine (17) may be positioned at the front of frame (12) or back of frame (12), but may be positioned in any other position on frame (12) which facilitates operation of imparting torque to axles (18, 19) to drive wheels (13, 14, 15, 16) to rotate, such as but not limited to positioned below seat (20).

Mower (10) may further comprise a mower deck (26) affixed upon or within frame (12) for trimming down vegetation from a grassy area in a manner well known in the art. A fuel container (24) may also be provided upon frame (12) for storing usable energy for operating engine (17) and mower deck (26). Fuel container (24) may be either a conventional gas tank for driving the movement of mower (10) by the burning of petroleum products in engine (17) or may be an electrical battery for driving engine (17) electrically. When configured as an electrical battery, fuel container (24) may be any conventional battery for operating a lawn maintenance vehicle, including but not limited to lead-acid (“flooded”, Deep cycle, and VRLA), NiCd, nickel metal hydride, lithium ion, Li-ion polymer, and zinc-air and molten salt batteries.

Furthermore, a sprayer mechanism (28) may be affixed within frame (12) upon the opposing side of frame (12) from mower deck (26). A permanently incorporated tank (30) may be provided upon frame (12) in fluid communication with sprayer mechanism (28) to feed liquid herbicides, fertilizers, pesticides, fungicides, insecticides and/or repellants and/or any fully dissolvable solid herbicides, fertilizers, pesticides, fungicides, insecticides, repellants, or other lawn management products (hereinafter “materials”) to sprayer mechanism (28) to distribute such materials upon a lawn or garden area.

Sprayer mechanism (28) comprises a nozzle (29) and pump (31), with nozzle (29) being in fluid communication with a pump (31) via extendable hose (42). In turn, pump (31) is in fluid communication with tank (30) via pump hose (44) for pumping materials from tank (30) through nozzle (29). Impelling materials for dispersal through nozzle (29) of sprayer mechanism (28) is preferably powered by a battery, either incorporated into engine (17), fuel container (24), or, as pictured, as an independent battery (32) affixed to frame (12) for use exclusively by sprayer mechanism (28). Battery (32) may be any conventional battery for operating a lawn maintenance vehicle or pump operated dispersal device, including but not limited to lead-acid (“flooded”, Deep cycle, and VRLA), NiCd, nickel metal hydride, lithium ion, Li-ion polymer, and zinc-air and molten salt batteries. Battery (32) may be incorporated and housed within frame (12) either as part of engine (16) or as an independent battery source for use by sprayer mechanism (28). In conventional prior art portable dispersal devices, a user typically must first impart pressure within the product by articulation or manipulation of a hand pump before dispersing materials. Powering sprayer mechanism (28) by engine (17), fuel container (24), or battery (32) relieves the necessity of requiring a driver of mower (10) to pump materials from sprayer mechanism (28) by hand, thus relieving the driver of any task loading while driving.

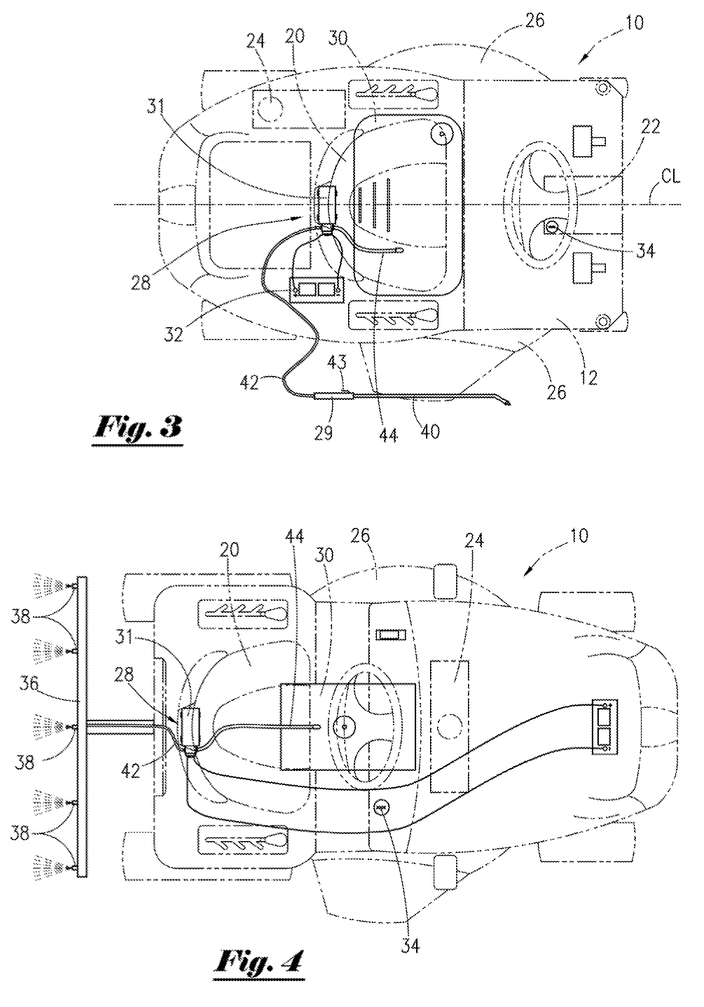

As can be seen in FIGS. 1-3, the sprayer mechanism (28), tank (30), and battery (32) may be positioned as necessary to maintain proper distribution of weight for operation of mower (10). Sprayer mechanism (28), tank (30), and battery (32) may be positioned along the centerline (CL) of frame (12) as to ensure that their additional weight will not offset the balance or weight distribution of mower (10) during operation. Furthermore, sprayer mechanism (28), tank (30), and battery (32) may be positioned upon the opposite sides of longitudinal centerline (CL) of frame (12) from mower deck (26) in a mower (10) where mower deck (26) is positioned off center from longitudinal centerline (CL). In a mower (10) which has a mower deck (26) positioned off center of centerline (CL), positioning sprayer mechanism (28), tank (30), and battery (32) as needed opposite of centerline (CL) to mower deck (26) will balance the offset created by the off-center positioning of mower deck (26). As well, with offset mower deck mowers (10) which further include clippings bags or containers (not pictured), additional adjustment of the positioning of sprayer mechanism (28), tank (30), and battery (32) upon frame (12) may be made to maintain a level distribution of weight.

Directing attention now to FIG. 3, in zero turn mowers and other mowers where mower deck (26) is positioned centrally on the longitudinal centerline (CL) of frame (12), sprayer mechanism (28), tank (30), and battery (32) may be positioned on the longitudinal centerline (CL) of frame (12) behind seat (20) to maintain level weight distribution. As depicted in FIG. 3, it is also possible for the sprayer mechanism (28), tank (30), and/or battery (32) to be positioned below seat (20), in front of seat (20), or separated to either side of the longitudinal centerline (CL) as desired to maintain the weight distribution of mower (10) where a component of mower (10) is positioned off-center, such as fuel tank (24) pictured.

Additionally, the versatility of positioning sprayer mechanism (28), tank (30), and battery (32) upon the frame (12) of mower (10) resolves the weight distribution problem which prompted some prior art mowers to divide their fuel into separate tanks to either side of seat (20), but which in turn created the problem of having to refill two separate fuel tanks prior to use. Rather, the permanent incorporation of sprayer mechanism (28) and tank (30) in mower (10) allows for mower (10) to have a single fuel container (24), wherein the sprayer mechanism (28), tank (30), and battery (32) will offset any off-center weight distribution of a full fuel container (24) and mower deck (26).

Sprayer mechanism (28) may be incorporated in mower (10) with a fixed and/or handheld nozzle (29). When fixed, it is preferable for nozzle (29) to be positioned at the rear of frame (12) behind seat (20). Positioned as such, materials sprayed from nozzle (29) will be distributed evenly behind mower (10) after each pass over an area. In a fixed configuration, as seen in FIG. 4, nozzle (29) may be configured as a single spray boom (36) with a wide dispersal pattern to distribute materials in a broad area behind mower (10), including but not limited to cone nozzles, rotary and broadcast spreaders, and drop spreaders, or as a boom (36) with a plurality of apertures (38) for distributing materials behind mower (10). Alternatively, nozzle (29) may also be positioned at the front of frame (12) to distribute materials ahead of mower (10) or on either side of seat (20), opposite to mower deck (26) on frame (12), to distribute materials alongside mower (10).

Directing attention to FIG. 1, in a hand held configuration, nozzle (29) is depicted as a spray wand (40), but may be any conventional handheld device for spraying fluid and solid materials, including but not limited to spray guns, cone nozzle guns, hose end sprayers, rotary and broadcast spreaders, and drop spreaders. In the handheld configuration wand (40) of sprayer mechanism (28) is connected to pump (31) via a flexible extendable hose (42) to allow for directed distribution of materials as desired. During operation of mower (10), the driver of mower (10) may use wand (40) for either broad dispersal of materials over a large area as mower (10) moves through or for pinpoint application of materials to a troublesome spot or hard to reach place in a lawn or garden area.

Both the fixed and handheld configurations of sprayer mechanism (28) may also be incorporated together in mower (10) in order to allow for broad dispersal of materials by the fixed boom (36), while allowing for directed application of materials as desired in specific areas with the handheld wand (40). Further, the flow of materials through both the fixed boom (36) and handheld wand (40) may be controlled by a demand switch (34) and/or trigger (43), either allowed to flow freely during the operation of mower (10) without any further input from the driver of the mower (10) or controlled by toggling of trigger (43) on wand (40). Demand switch (34) may be positioned in any convenient location on mower (10) to toggle the operation of pump (31) to cause materials to be driven to and through nozzle (29), though it is envisioned that switch (34) may be positioned on the steering mechanism (22) or upon frame (12) and trigger (43) to be positioned upon wand (40). Using either the spray wand (40) and/or boom (36), materials comprising, but limited to, liquid and/or fully dissolvable solid fertilizers, pesticides, fungicides, insecticides and/or repellants can be applied while the operator is cutting grass and/or applied at any desirable time while operating the mower (10).

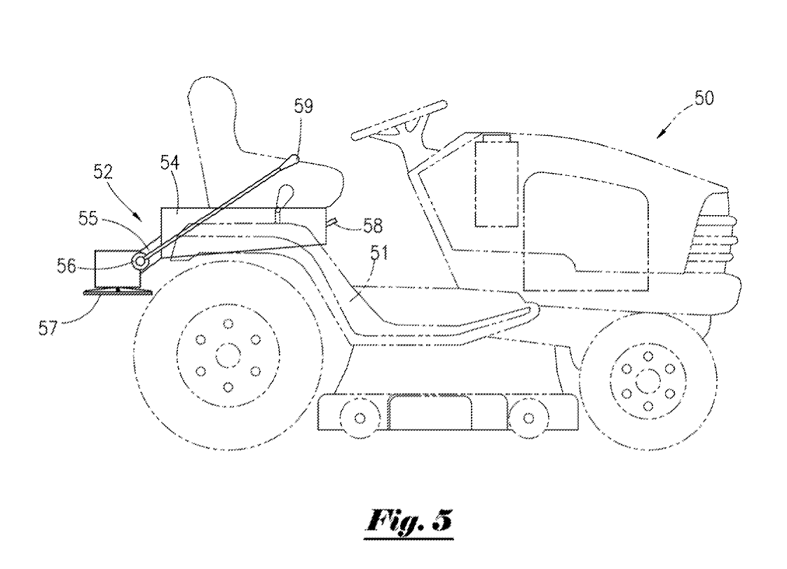

Referring now to FIG. 5, an alternative embodiment of mower (10) is directed to a mower (50), as previously described, but which comprises a dry solids dispersal sprayer mechanism (52), wherein materials are gravity fed to solids dispersal sprayer mechanism (52) from a solids hopper (54). Solids dispersal sprayer mechanism (52) is in communication to transfer solids from solids hopper (54) to solids dispersal sprayer mechanism (52) by materials passage (55). Materials passage (55) may be any chute, channel, conduit, duct, pipe, tube, or other conventional means for allowing passage of dry solids therethrough.

Solids hopper (54) may be equipped with an articulable access (56) for controlling the flow of materials from hopper (54) into passage (55). A switch (58), like that of demand switch (34) of the previous embodiment, or lever (59) may be positioned in any convenient location on mower (50) to toggle access (56) to open or close to either begin feeding materials to be released from solids hopper (54) and gravity fed through passage (55) to solids dispersal sprayer mechanism (52). It is envisioned that switch (58) be positioned on steering mechanism (53) of mower (50), though may be located anywhere upon framework (51) to allow for ease of toggling switch (58).

Similar to that of sprayer mechanism (28) and tank (30), dry solids dispersal sprayer mechanism (52) and solids hopper (54) may be positioned and affixed upon the framework (51) as desired to maintain proper weight distribution of mower (50). It is preferred that solids dispersal sprayer mechanism (52) be positioned at the rear of mower (50) as to distribute solid materials behind mower (50) as it is driven, just as with boom (36) of sprayer mechanism (28), though it is envisioned that solids dispersal sprayer mechanism (52) may also be positioned at the front of framework (51) to distribute materials ahead of mower (50) or on either side of seat (56), opposite to mower deck (58) on framework (51), to distribute materials alongside mower (50).

Solids dispersal sprayer mechanism (52) may be configured to provide a wide dispersal pattern to distribute materials in a broad area around mower (50). Solids dispersal sprayer mechanism (52) is envisioned to be configured as rotary, broadcast, or drop spreader (57), though could also be any other dry solids distribution means conventional for spreading materials behind mower (50). Similar to sprayer mechanism (28), solids dispersal sprayer mechanism (52) may be configured to either dispense materials in a free flow during use of mower (50) or on demand by toggling of switch (58).

In operation, mowers (10, 50) are capable of both trimming a lawn or garden area with mower deck (26), as well as application of materials to the area following the path which mowers (10, 50) are driven. Thus, reducing extra work for a user while promoting a well-manicured and fertilized lawn or garden free of pests. Further, due to the permanent incorporation of sprayers (28, 52) into mowers (10, 50), the weight distribution of mowers (10, 50) will remain balanced and be less likely to cause ruts or gouges in a lawn and garden.

It is thought that the mowers (10, 50) and the method of operation of the present invention and their attendant advantages will be understood from the foregoing description. It is also thought that one may make various changes in the form, construction and arrangement of the parts of the mowers (10, 50) described, such as use of inline strainers, demand switch model pumps, and incorporation of the sprayer mechanism (28, 52) into push driven mowers without sacrificing their material advantages or departing from the spirit and scope of the invention.

I claim:

1. A lawnmower material spraying apparatus comprising:
a. a lawnmower frame, wherein said lawnmower frame comprises at least two front wheels and at least two rear wheels, a front axle connecting said front wheels, a rear axle connecting said rear wheels, and a steering mechanism;
b. a mower deck affixed to said frame;
c. a sprayer mechanism permanently incorporated into said lawnmower frame, said sprayer mechanism comprising a tank in fluid communication with a pump, wherein said pump is in fluid communication with a nozzle for discharging materials within said tank; and
d. an engine housed within said frame for application of torque to drive movement of said axles, said engine connected to a fuel container for powering said engine.

2. The lawnmower material spraying apparatus of claim 1, wherein:
a. said lawnmower frame further comprises a longitudinal centerline; and
b. said mower deck, said sprayer mechanism, said engine, and said fuel container are incorporated into said lawnmower frame to equally balance weight distribution on either side of said longitudinal centerline of said lawnmower frame.

3. The lawnmower material spraying apparatus of claim 2, further comprising a hose in fluid communication between said nozzle and said pump, wherein said pump drives said materials housed within said tank through said hose and out of said nozzle.

4. The lawnmower material spraying apparatus of claim 3, wherein said sprayer mechanism is powered by an independent battery affixed to said frame.

5. The lawnmower material spraying apparatus of claim 4, wherein said sprayer mechanism is controlled by a switch.

6. The lawnmower material spraying apparatus of claim 5, further comprising a battery connected to said pump of said sprayer mechanism.

7. The lawnmower material spraying apparatus of claim 6, further comprising a seat affixed upon said lawnmower frame, wherein said steering mechanism is attached to said front or rear axle for directing the movement of said front or rear wheels.

8. The lawnmower material spraying apparatus of claim 7, wherein said engine imparts torque to said front axle to rotate said front wheels.

9. The lawnmower material spraying apparatus of claim 7, wherein said engine imparts torque to said rear axle to rotate said rear wheels.

10. The lawnmower material spraying apparatus of claim 7, wherein said engine imparts torque to said front axle and said rear axle to rotate said front wheels and said rear wheels.

11. The lawnmower material spraying apparatus of claim 2, wherein said nozzle of said material sprayer is permanently incorporated upon said lawnmower frame.

12. The lawnmower material spraying apparatus of claim 7, wherein said nozzle of said material sprayer is permanently incorporated upon said lawnmower frame.

13. A lawnmower liquid material spraying apparatus comprising:
a. a lawnmower frame, said lawnmower frame having a longitudinal centerline, front wheels and rear wheels, a front axle connecting said front wheels, a rear axle connecting said rear wheels, and a steering mechanism;
b. a mower deck affixed to said frame;
c. a liquid sprayer mechanism permanently incorporated into said lawnmower frame, said liquid sprayer mechanism comprising a tank in fluid communication with a pump, wherein said pump is in fluid communication with a nozzle for discharging materials within said tank, wherein the pumping of said materials by said pump from said tank and through said nozzle is controlled by a switch, said sprayer mechanism is powered by an independent battery; and
d. an engine housed within said frame for application of torque to drive movement of said axles, said engine connected to a fuel container for powering said engine, wherein said mower deck, said liquid sprayer mechanism, said engine, and said fuel container being incorporated into said lawnmower frame to equally balance weight distribution on either side of said longitudinal centerline of said lawnmower frame.

14. The lawnmower liquid material spraying apparatus of claim 13, further comprising a hose in fluid communication between said nozzle and said pump of said liquid sprayer mechanism, wherein said pump drives said liquid materials housed within said tank through said hose and out of said nozzle.

15. The lawnmower material spraying apparatus of claim 14, further comprising a seat affixed upon said lawnmower frame, wherein said steering mechanism is attached to said front or rear axle for directing the movement of said front or rear wheels.

16. A lawnmower solid material spraying apparatus comprising:
a. a lawnmower frame, said frame having a front and rear end, at least two front wheels and at least two rear wheels, a front axle connecting said front wheels, a rear axle connecting said rear wheels, and a steering mechanism;
b. a mower deck affixed to said frame;
c. a solid sprayer mechanism permanently incorporated into said lawnmower frame, said sprayer mechanism comprising a hopper in communication with a chute, wherein said chute is in communication with a spreader for discharging materials from said hopper; and
d. an engine housed within said frame for application of torque to drive movement of said axles, said engine connected to a fuel container for powering said engine.

17. The lawnmower solid material spraying apparatus of claim 16, wherein said solid sprayer mechanism is permanently affixed to said rear end of said frame for dispersal of solids behind said lawnmower.

18. The lawnmower material spraying apparatus of claim 17, further comprising a seat affixed upon said lawnmower frame, wherein said steering mechanism is attached to said front or rear axle for directing the movement of said front or rear wheels.
